(19) United States
(12) Patent Application Publication
(10) Pub. No.: US 2003/0122865 A1
(43) Pub. Date: Jul. 3, 2003

(54) Methods and apparatus for user directed banner displays and web page navigation

(76) Inventors: Adam T. Lake, Portland, OR (US); Carl S. Marshall, Portland, OR (US); Chris B. Wilkerson, Portland, OR (US)

Correspondence Address: James H. Salter, Blakely, Sokoloff, Taylor & Zafman Name LLP, Seventh Floor, 12400 Wilshire Boulevard, Los Angeles, CA, 90025-1030, US

(21) Appl. No.: 10/039,740

(22) Filed: Jan. 3, 2002

(51) Int. Cl. G09G 5/00

(52) U.S. Cl. 345/738

(57) ABSTRACT

Methods and apparatuses to view information include, ordering a list of information content segments that have previously appeared on a web page, wherein the web page is displayed in a first area of an information display and displaying the list of information content segments to be viewed concurrently with the web page.

### BACKGROUND OF THE INVENTION

1. Field of Invention

This invention relates generally to information displays and more specifically to ordered lists of information content and methods of navigating through the lists.

2. Art Background

“Web sites,” such as those created for use with the Internet are designed to deliver or display “web pages” to a user. The user selects or “clicks” to proceed to a subsequent page or to move back to a preceding page. The web pages are often interspersed with general information content. The information content can take the form of advertisements. In a typical session of viewing content on a web site, the user proceeds through multiple pages and may take notice of information content occurring on a particular page. Upon deciding that some information content previously viewed on the particular page was of interest, the user backs up to the previously viewed page. Often, the particular information content that motivated the user to back up to the previously viewed page is no longer available once the user returns to the page. When the user returns to the page, the information is no longer available because the web page and the information displayed thereon is not necessarily synchronized to provide the same information on subsequent displays of the page.

Often, a style sheet is used to provide organization to the web page. Information content posted to a given web page and formatted with the style sheet changes with time. For example, timing may be structured to change information content posted to the page at a predetermined time interval. Timing may also be structured to change or rotate information content posted to the page every time the page is loaded in response to a user request to view the page. These mechanisms for changing the information content displayed to the web page can be used to place different ads in front of users of the web site. The lack of consistency between a subsequent viewing of the web page and the first viewing results in the user not being able to return and view information content seen on the first viewing of the web page.

### BRIEF DESCRIPTION OF THE DRAWINGS

The present invention is illustrated by way of example and is not limited in the figures of the accompanying drawings, in which like references indicate similar elements.

FIG. 1A illustrates an ordered list of previously displayed information content segments.

FIG. 1B is a flow chart of a method employing the present invention to view previously displayed information content.

FIG. 2 embodies several methods of navigating through a list of information content segments.

FIG. 3 depicts one embodiment of associating an ordered list of previously displayed information content segments with an area of an information display.

FIG. 4 illustrates another embodiment of a method to display an ordered list of previously displayed information content segments.

FIG. 5 shows an association of an active web page viewing area, of an information display, proximate to an ordered list of nodes.

FIG. 6 illustrates another embodiment of an association of an active area of an information display proximate to an ordered list.

FIG. 7 illustrates several methods of navigating an ordered list and associating the ordered list.

FIG. 8 illustrates several techniques for navigating and associating information content and the web page from which the information content is derived.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

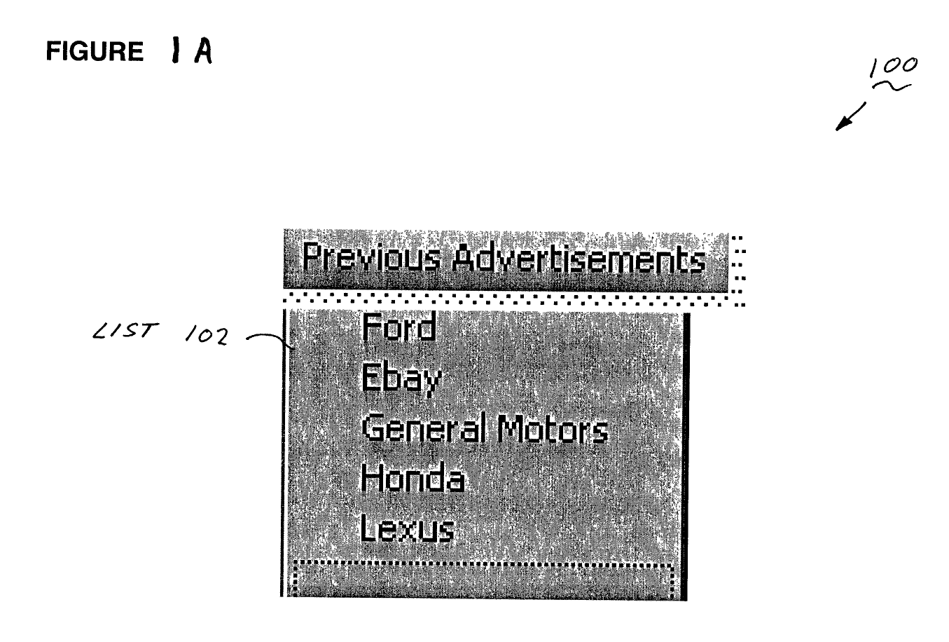

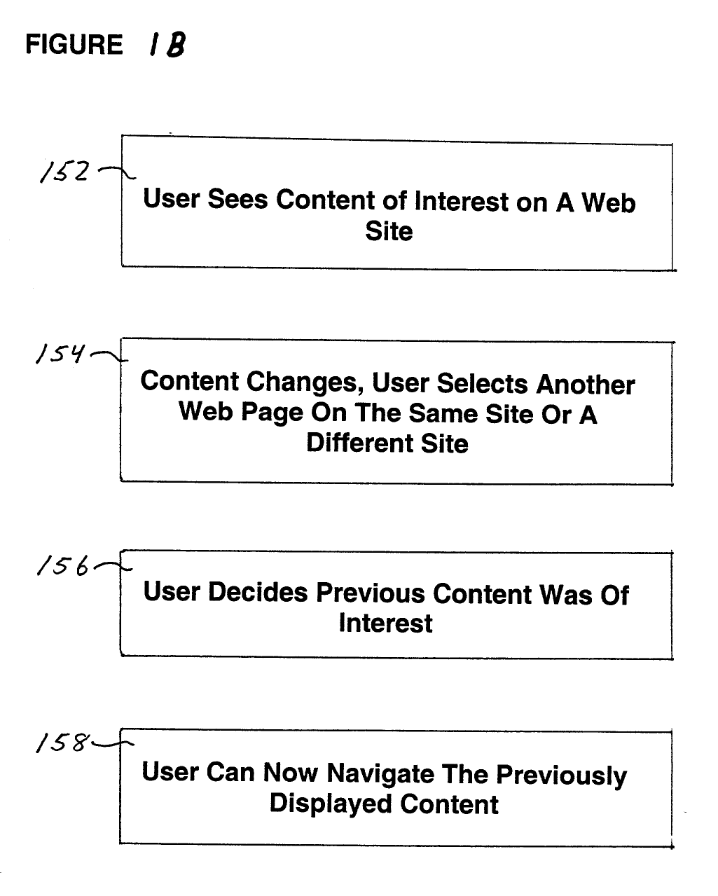

Methods and apparatuses for user directed recall of information content are described herein. The information content, or links to the information content previously viewed, are formed into a list and displayed according to a number of embodiments of the present invention. One such embodiment is illustrated in FIG. 1A at 100. A list 102 of previously viewed information content is shown in FIG. 1A. The list 102 includes an ordered list of links to information content. In the example chosen for FIG. 1A, the information content can be advertisement information content. However the teachings according to the present invention are applicable to general information content and are not constrained to advertisement content. Advertisement information content is used merely as an illustration of one embodiment of the present invention.

The order embodied in the list 102 may be patterned in different ways. For example, the order may be a chronological order corresponding to the web pages visited by the user. Alternatively, the order can be a topical order wherein the previously viewed information content is ordered by topic, such as cars, computers, travel, etc. The list could embody a random order, which could also be characterized as a lack of order. The list 102 could represent a topical order or a chronological order; the present invention is not constrained by the order or lack of order embodied within the list of information content.

In one embodiment, the links shown at 102 (FIG. 1A) can represent the advertisements that have been posted to one or more previously viewed web pages. The present invention permits the user to effectively navigate backward to one of the previously viewed web pages and observe that page in the same form as when the page was viewed in the first instance. The previously displayed information content may be displayed in a variety of ways. According to one method, information content can be redisplayed by triggering an event (a combination of software/hardware interactions) that brings up either locally cached data pertaining to the link or by sending the event back to a server which has the ability to recall the information content associated with the link. Implementation of the latter may involve requiring the data to be sent to an advertising server that actually stores the advertisement data. The data can then be forwarded to the user's web browser.

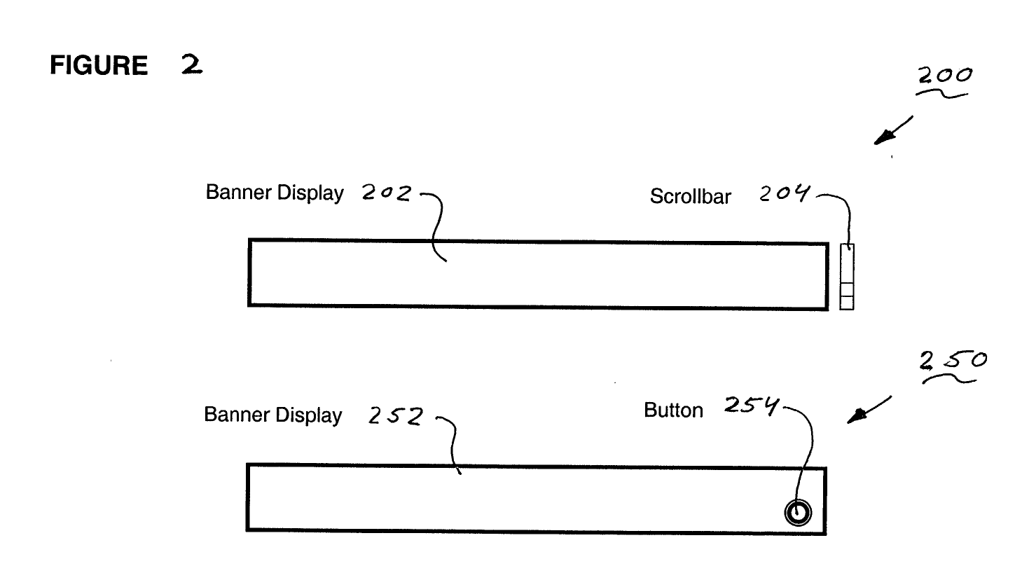

FIG. 1B is a flow chart of a method employing the present invention to view previously displayed information content. The user sees a variety of information content when viewing web pages at 152. The user proceeds to subsequent pages on the present site or another site at 154. After thinking about what was previously viewed, the user decides to cycle backward to review a previously observed information content at 156. The user can now navigate through the previously displayed content at 158 according to the methods and apparatuses described in conjunction with FIG. 1A above and FIG. 2 through FIG. 8 discussed below. The present invention is not constrained or limited by web site design. As such, the present invention can present a list of links to previously viewed information content that may have come from a plurality of web sites previously visited.

Additional methods may be employed to permit the user to navigate through previously displayed information content. FIG. 2 embodies several methods of navigating through a list of information content segments. With reference to FIG. 2, an information content retrieved by selecting (such as clicking) a link associated with a banner display 202 can be adjusted by the use of scroll bar 204 as shown in 200. The scroll bar 204 can allow a list similar to 102 (FIG. 1A) to be displayed row by row within 202. Clicking on the link posted to the banner display 202 can result in the redisplay of the information content associated with the link therein. Accordingly, the user can navigate through the list of links associated with the scrollbar 204.

Another method, shown at 250, of navigating through the list of previously displayed information content can be performed by use of a button 254. A banner display 252 can be configured with the button 254 to provide navigation through the list of links to previously displayed information content. The button 254 can be configured as a single button that cycles through the list of information content, or the button can be a multi-position button that permits forward and backward navigation through the list of information content.

The list of previously displayed information content can refer to the link, the banner display or a more extensive compilation of information content such as a web page or portion thereof. Thus, when reference is made to the link, the banner page, or the information content, all three terms may be used interchangeably. In embodiments of the present invention tailored for operation on lower performance hardware platforms, it may be desirable to employ the present invention by presenting the user with a list of links as shown in FIG. 1B at 100. Embodiments of the present invention operating on higher performance hardware platforms can present the user with a greater amount of information content either previously viewed or potentially viewable.

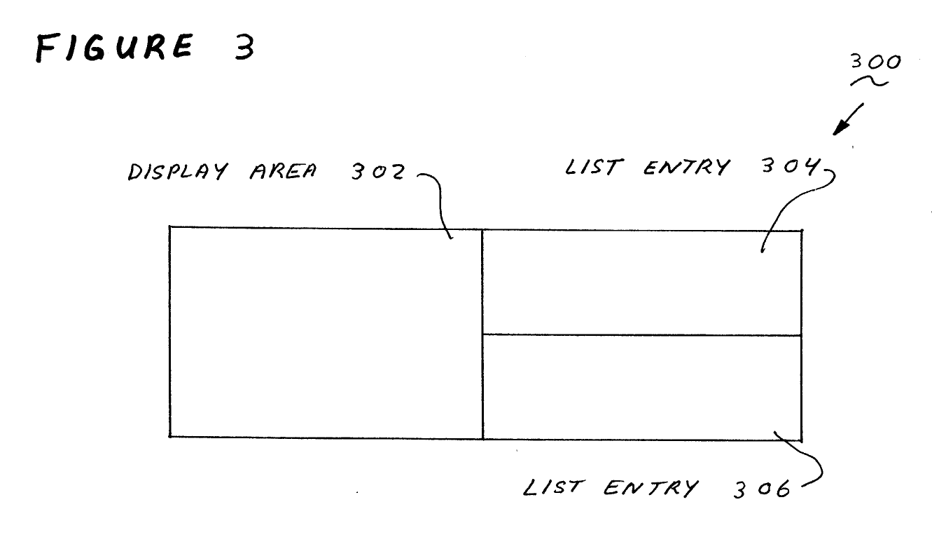

The lists, previously described, can be associated with the web page from which they were derived. FIG. 3 depicts one embodiment of associating an ordered list of previously displayed information content segments with an area of an information display as shown at 300. Such an association, as shown at 300, can be referred to as a node. With reference to FIG. 3, display area 302 represents content of a typical web page. Two entries from a list of information content, which were displayed within the display area 302, are shown as list entry 304 and list entry 306.

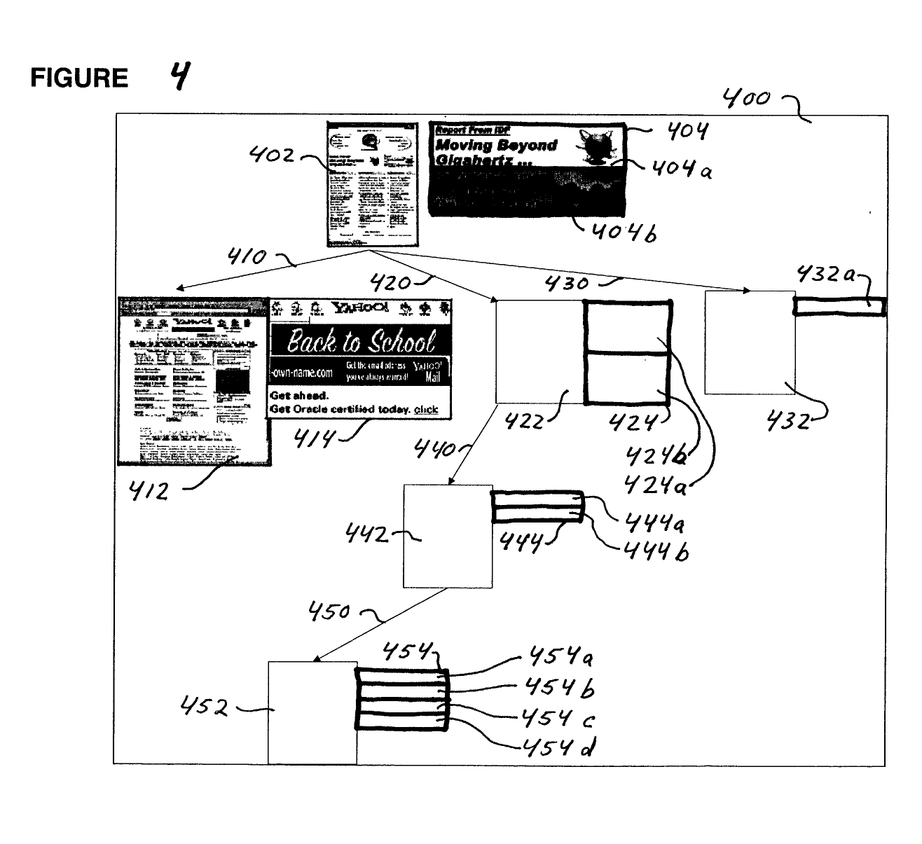

In one embodiment, the association of information content segments and the web page from which they are derived can be extended to illustrate a user's web viewing session as shown in FIG. 4. FIG. 4 illustrates another embodiment of a method to display an ordered list of previously displayed information content segments which provides the user with a method of navigation between the nodes or elements in the list. In this embodiment, the ordered list becomes a series of nodes (web pages and their corresponding information content segments). With reference to FIG. 4, a display area 400 contains a list of six previously viewed web pages and their corresponding information segments. A first web page viewed in a user's web browsing session is shown at 402. The first web page viewed 402 can be a thumbnail image of the actual web page represented thereby. The list of information content segments deriving from web page 402 is indicated by area 404. Area 404 is made up of two information content segments, 404a and 404b. Display of the web page and the information content depending therefrom allows the user to quickly find a particular information content segment of interest. Location of the information content segment of interest allows the user to return to the exact information content segment by selecting or clicking on the link. Thus, the current problem of waiting for the information content segment to be redisplayed on the web page is eliminated by providing the user with the means to self-direct control of the web browser back to the particular link represented by the information content segment of interest.

Additional web pages visited by the user during the web browsing session are illustrated with control arrow 410 indicating another web page visited at 412 and corresponding information content segments 414. A third web page visited is indicated by control arrow 420 leading to web page 422 with corresponding information content segments 424 including 424a and 424b. A fourth web page visited may be indicated by either control arrow 430 or 440, depending on the path taken by the user. For this discussion it will be assumed that control arrow 440 indicated the fourth web page visited at 442, with information content segments 444 including 444a and 444b. A fifth web page visited may be indicated by control arrow 450 leading to web page 452 with information content 454 including 454a, 454b, 454c, and 454d. A sixth web page visited may be indicated by control arrow 430 leading to web page 432 with information content segment 432a.

In the preceding discussion, it is not important which order the user proceeded in the visit of the web pages, many conventions can be used and the present invention is not limited thereby. For example, chronological order may be implied with the convention that time increases from left to right across the width of display area 400. Additionally, the convention that time increases from top to bottom may be employed as well. The connectivity indicated by control arrows 410, 420, 430, 440, and 450 may be useful to help the user remember the path taken during the web browsing session. The control arrows can be numbered (not shown) according to the chronological order pertaining to the user's web viewing session.

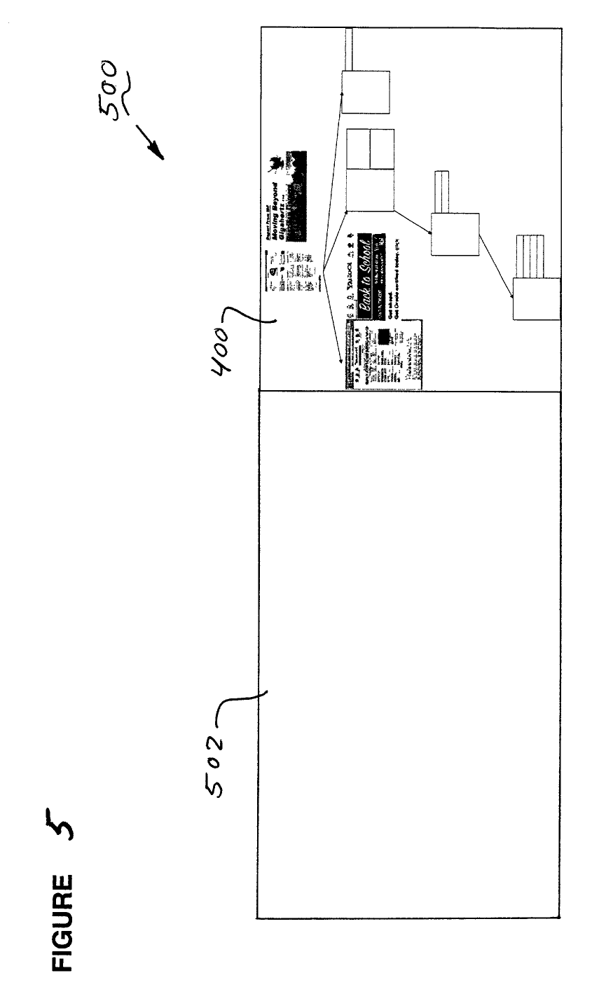

The navigational apparatuses and methods associated with FIG. 4 can occupy a portion of an information display in combination with an active web page viewing area. FIG. 5 shows an association of an active web page viewing area 502, of the information display, proximate to an ordered list of nodes within the display area 400, wherein the list of nodes follows the association described in conjunction with FIG. 4. The display of the active or primary web page viewing area 502 and the ordered list of nodes contained within 400 provides an ability to navigate web information that is more visual than the experience provided by existing web browsers. The user is provided with an enhanced “view” of the web as well as control over the information previously displayed.

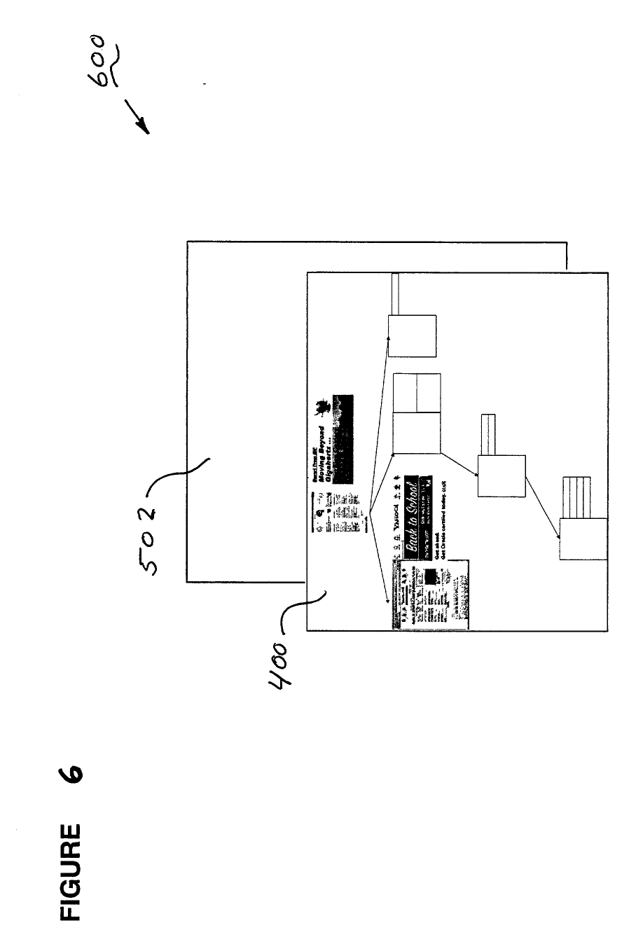

FIG. 6 illustrates another embodiment of an association of an active area of an information display proximate to an ordered list. With reference to FIG. 6, the active web page viewing area 502 can be placed in a background position relative to the area of the information display 400 used to contain the nodes. The user can move 502 into the foreground by clicking on any portion of 502 according to the techniques that are well known in the art. Alternatively, the relative areas of 502 and 400 can be resized according to the techniques that are well known in the art.

Additional functionality, such as the ability to enlarge a single node of interest, can be incorporated into the navigational methods taught herein, which allows the user to focus attention on a particular node and view the thumbnail as an enlarged active web page with the full compliment of information displayed thereon. The multiple viewing area described in conjunction with FIG. 6 can be employed to allow multiple areas of previously viewed nodes as the user's web viewing session grows. Thus, there can be a plurality of areas 400 (not shown) which would contain the user's web viewing history. The user could select the appropriate area by clicking thereon as previously described.

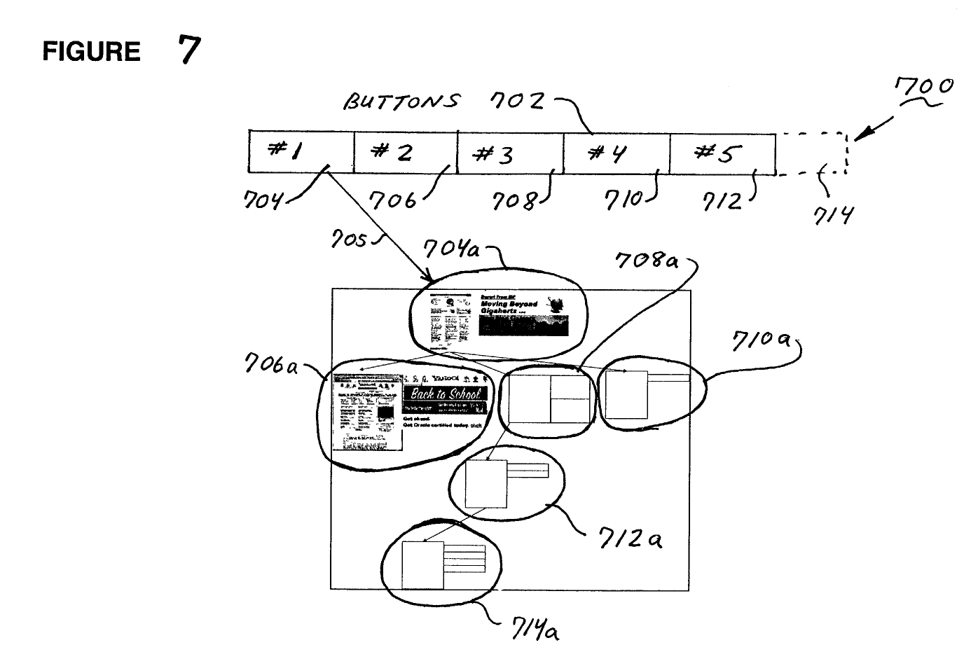

In the alternative, or in addition to the techniques previously taught, navigation of the web viewing session can be accomplished with a plurality of buttons as shown in FIG. 7. FIG. 7 illustrates several methods of navigating an ordered list and associating the ordered list with the order visited by the user. With reference to FIG. 7, a plurality of buttons 702 contains buttons 704, 706, 708, 710, and 712. The plurality of buttons 702 may include more buttons than are visible within 702. For example, 702 may provide a window of visible buttons out of a large group. In one embodiment, functionality exists within a software/hardware implementaion to allow the user to scroll forward or backward, thereby providing access to a subset of buttons from the larger group. This technique can be useful when the web viewing session has grown so large that the physical display device does not provide enough area to accommodate posting all the buttons pertaining to the web viewing session.

In one embodiment, each button within the plurality of buttons 702 can be configured according to a variety of ways to allow the user to navigate through the web viewing session. For example, clicking on button 704 can trigger the display of node 704a as indicated by control arrow 705. A second node corresponding to a subsequent web page viewed by the user can be displayed by clicking on the button 706 which could initiate the display of node 706a. Similarly, nodes 708a, 710a, and 712a can be displayed by clicking on the respective button. A dashed line indicates a button, not yet visible, at 714. The button 714 would become visible as the user scrolled through the plurality of buttons as previously described. Clicking on button 714 will cause the display of node 714a.

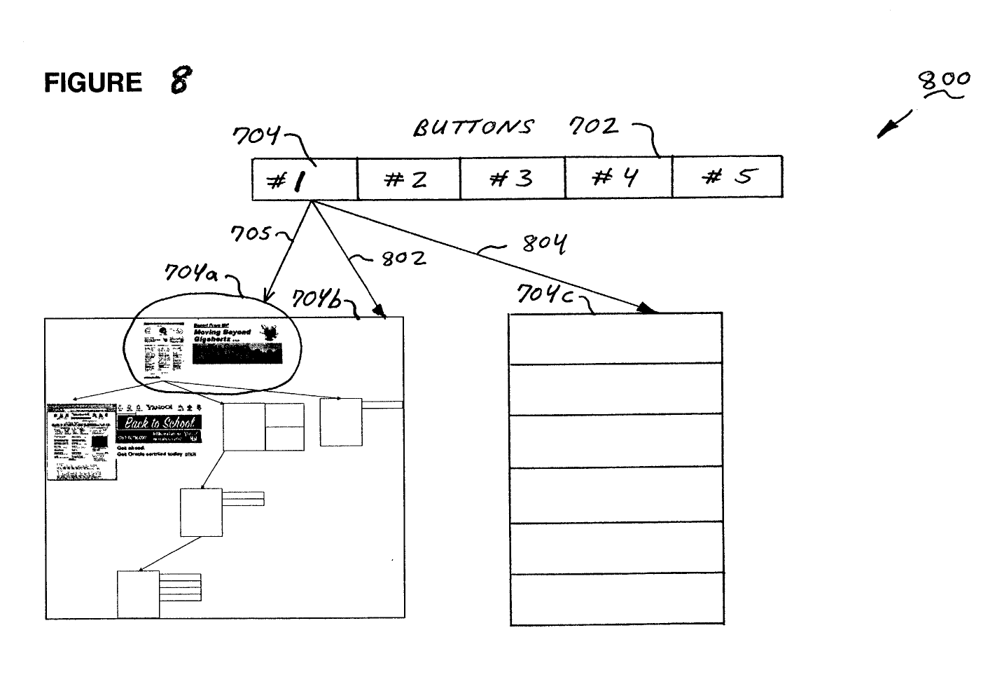

In another embodiment, another method of providing navigation through the list of information content observed during the web viewing session is shown in FIG. 8. With reference to FIG. 8, selecting the button at 704 can provide additional display formats to facilitate navigation through the previously viewed web pages. For example, selecting the button at 704 can cause display area 704b to be displayed, which would display the plurality of nodes shown therein. Another display format is shown with control arrow 804 resulting in table 704c. Table 704c can list the links corresponding to previously viewed information content. In one embodiment, the table 704c can resemble the list 102 (FIG. 1A).

Throughout this description, reference has been made to clicking. It is well known in the art that clicking is commonly used to describe selecting with a pointing device such as a mouse. Any method of selecting can be utilized within the teaching of the present invention, such as clicking with a pointing device. Such additional methods of selecting include, but are not limited to, voice activation or touch panel selection with a stylus. The present invention is not limited by the method employed to perform the selection.

In one or more embodiments, the present invention has been described for use in which previously viewed advertisements are redisplayed at the command of the user. The present invention can be used as a tool to increase the revenue of an advertiser in a case where an advertiser pays for each “display” of an ad. When a user triggers an event which results in the ad being redisplayed, the operator of the web site receives increased revenue beyond the revenue, which would be generated by the present method of posting the ad at a set interval in time that is beyond the control of the user.

The present invention can be used in existing web browsers such as those employed by AOL™, Microsoft™, etc. The capability described herein can be provided as an add-on, plug-in, or option in software.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

Thus, novel ways of allowing a user to view information content previously viewed and methods of navigating through the information content are described. Although the invention is described herein with reference to specific preferred embodiments, many modifications therein will readily occur to those of ordinary skill in the art. Accordingly, all such variations and modifications are included within the intended scope of the invention as defined by the following claims.

What is claimed is:

1. A method to view information comprising:
ordering a list of information content segments that have previously appeared on a web page, wherein said web page is displayed in a first area of an information display; and
displaying said list of information content segments to be viewed concurrently with said web page.

2. Said method of claim 1, wherein said ordering follows a chronological order of display.

3. Said method of claim 1, further comprising:
associating said first area of said information display with said list of information content segments.

4. Said method of claim 3, wherein said associating places said first area of said information display proximate to said list of information content segments.

5. Said method of claim 1, wherein said information display is a projection of light on a surface.

6. Said method of claim 1, wherein said information display is comprised of electrically powered display elements.

7. Said method of claim 1, further comprising navigating through said list of information content segments.

8. Said method of claim 7, wherein said navigating is performed with at least one of a scroll bar, a button, and a voice command.

9. Said method of claim 1, wherein said information content is an advertisement.

10. A computer readable medium containing executable computer program instructions, which when executed by a data processing system, cause the data processing system to perform a method to view information comprising:
ordering a list of information content segments that have previously appeared on a web page, wherein said web page is displayed in a first area of an information display; and
displaying said list of information content segments to be viewed concurrently with said web page.

11. Said computer readable medium as set forth in claim 10, wherein said ordering follows a chronological order of display.

12. Said computer readable medium as set forth in claim 10, wherein the method further comprises associating said first area of said information display with said list of information content segments.

13. Said computer readable medium as set forth in claim 12, wherein said associating places said first area of said information display proximate to said list of information content segments.

14. Said computer readable medium, as set forth in claim 10, wherein the method further comprises navigating through said list of information content segments.

15. Said computer readable medium, as set forth in claim 14, wherein said navigating is performed with at least one of a scroll bar, a button, and a voice command.

16. Said computer readable medium, as set forth in claim 10, wherein said information content is an advertisement.

17. An apparatus comprising:
a web page;
a first area of an information display, wherein said web page to be displayed in said first area of said information display; and
an ordered list of information content segments that have previously appeared on said web page, wherein said ordered list of information content segments to be displayed on said information display and to be viewed concurrently with said web page.

18. Said apparatus of claim 17, wherein said ordered list follows a chronological order of display.

19. Said apparatus of claim 17, wherein said first area of said information display is associated with said list of information content segments.

20. Said apparatus of claim 19, wherein said associated places said first area of said information display proximate to said list of information content segments.

21. Said apparatus of claim 17, wherein said information display is a projection of light on a surface.

22. Said apparatus of claim 17, wherein said information display is comprised of electrically powered display elements.

23. Said apparatus of claim 17, wherein said apparatus to permit navigation through said list of information content segments.

24. Said apparatus of claim 23, wherein said navigation to be performed with at least one of a scroll bar, a button, and a voice command.

25. An apparatus comprising:
a means for ordering a list of information content segments that have previously appeared on a web page, wherein said web page to be displayed in said first area of said information display; and
a means for associating said list with said first area, wherein said list to be viewed concurrently with said web page.

26. Said apparatus of claim 25, wherein said means for ordering uses a chronological order.

27. Said apparatus of claim 25, further comprising:
a means for navigating said list.
